(19) United States
(12) Patent Application Publication
(10) Pub. No.: US 2012/0152385 A1
(43) Pub. Date: Jun. 21, 2012

(54) FLUID TREATMENT DEVICE

(75) Inventor: Seppo Ketola, Espoo (FI)

(73) Assignee: Septor Technologies B.V., Utrecht (NL)

(21) Appl. No.: 13/388,590

(22) PCT Filed: Mar. 18, 2010
(86) PCT No.: PCT/FI2010/050211

§ 371 Date: Feb. 2, 2012

(30) Foreign Application Priority Data
Mar. 31, 2009 (NL) 2002687

(51) Int. Cl. F16K 3/08; F16K 11/074

(52) U.S. Cl. 137/625.46; 251/208

(57) ABSTRACT

Fluid treatment device and valve assembly therefore. The fluid treatment device comprises rotary columns or other containers which are alternately subjected to different fluid streams. In order to effect the required connection to different feed and discharge lines on the stationary part of the device, a valve assembly is proposed comprising a stationary and rotary valve plate. The front surfaces of these valve plates are directed towards each other. Optimum mating properties have been realised by producing one front surface from a plastic material and more particular a Teflon based material whilst the other front surface is produced from a polyethylene and more particular ultra high molecular weight polyethylene. This combination allows for a wide temperature range and a large number of fluids to be conveyed.

The present invention relates to a valve assembly for a fluid treatment device comprising a stationary valve plate being provided with fluid channels, said fluid channels extending from first openings in a front surface of said valve plate to fluid line connections on said valve plate, and a rotary valve plate having a front surface provided with second openings opening in fluid channels in said rotary valve plate, said front surfaces of said stationary and rotary valve plate being directed towards each other and wherein said first and second openings are positioned in register in determined relative rotative positions of said stationary and rotary valve plate.

Such a valve assembly is generally known in the art and as example EP 1067997 B1 of patentee is mentioned.

Such a valve assembly is used in a fluid treatment device wherein fluid is transferred to columns or containers and is subjected to a treatment in such columns. Due to the nature of the treatment a regular change in the feed and discharge for the columns is necessary. For example regeneration of the columns might be a part of the operation sequence.

To that end the columns are provided on a rotating carrier which is rotatively connected with the rotary part of the above valve assembly. A stationary part of the valve assembly is present and in both valve parts or valve plates fluid channels extend. At the opposite front surfaces openings or slits are provided and through relative rotation blocked followed by other different connection between fluid lines.

However it should be noted that subject application also relates to a more complicated valve assembly wherein rotation is effected as indicated above but due to the “multiple” embodiment of the valve assembly the columns are no longer rotating.

The interface between the rotating front surface of the rotary plate and the stationary front surface of the stationary valve plate should meet a number of requirements. First of all it should stand the fluid used in the device. More particular corrosion or other attack should be avoided. Furthermore it should be able to withstand the temperatures (hot or could), pressures or changing of the related fluids.

A further important requirement is the friction generated between the front surfaces and the compatibility of both materials.

In the prior art a combination of plastic material for one front face and hastelloy for the other one has been proposed. Although this might function properly for some applications the price for hastelloy has been increased in the present years in such an amount that the cost price for material alone is an essential part of the final price of the valve assembly. Tests have conducted with stainless steel-plastic combinations which were however not satisfying. More particular the combination stainless steel-PTFE material revealed flaking of the PTFE (Teflon) material.

The invention aims to provide a valve assembly comprising a combination of cooperating front surfaces which can be used for a wide range of applications, temperatures and pressures and having relatively long service life. Furthermore the used materials should be relatively inexpensive.

According to subject invention this aim is realised with a valve assembly having the characterizing features of claim 1.

Surprisingly it has been found that the combination plastic-polyethylene based plastic has improved friction properties. This means that the forces for rotating the several components of the valve assembly relative to each other can be low. Furthermore is has been found that damage to one of the front surfaces is relatively rare. The related plastic materials is chosen based on the resistance against the aimed fluids, temperature and pressure.

More preferable the polyethylene based plastic material comprises an ultra high molecular weight polyethylene. More particular, such material has a molecular weight of at 1,000,000-10,000,000 g/mol and more particular between 2,000,000 and 8,000,000 g/mol.

As indicated above the plastic material of “the other” of said valve plate can comprise any plastic material meeting the requirements for withstanding the treatment in the fluid treatment device. However according to a preferred embodiment of the invention for this other plate a Teflon (PTFE) material is used. More particular it has been found that the combination PTFE and ultra height molecular weight PE gives optimum results both with regard to friction, damaging of the front surfaces i.e. service life as well resistants against the most commonly used fluids, temperatures and pressures.

If plastics are used for the front or sealing surfaces for valve plates preferably a backing or support comprising a metallic material is provided. However the requirements set to such material are relatively low and can be focussed on strength. If the fluid conduits extend through such metallic plates at the transition of plastic material and metal preferably an O-ring is provided for sealing.

The invention also relates to a fluid treatment device comprising a carrier for a fluid treatment column, said column being provided with a feed and discharge line being connected to a rotating valve assembly as described above, wherein the rotary valve plate thereof is substantially corotating with said carrier, and said stationary valve plate is provided with feed and discharge conduits.

The invention will be further elucidated referring to an embodiment as example shown in the figures, wherein:

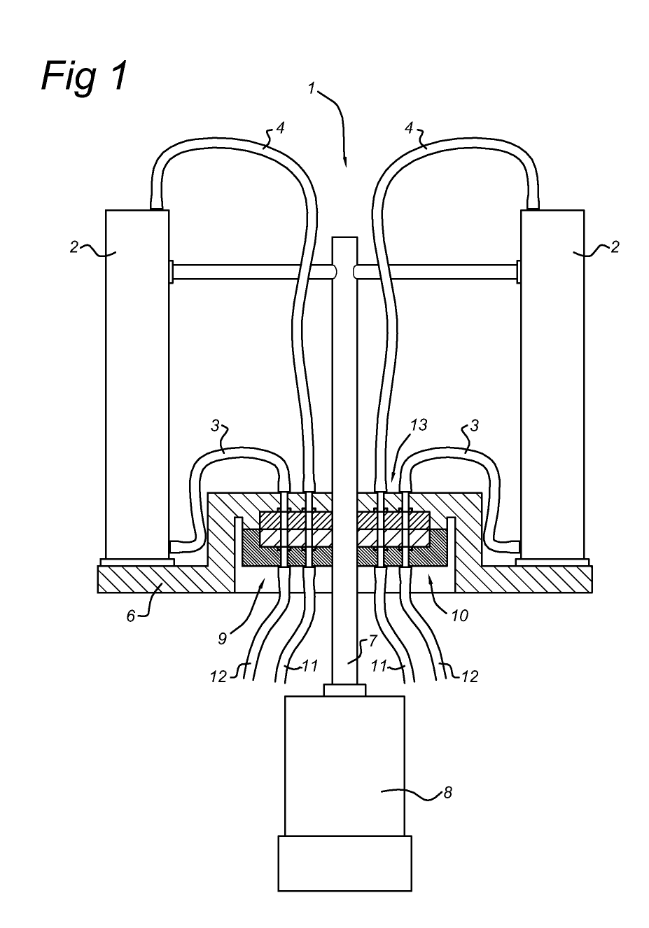

FIG. 1 shows the most relevant parts of a fluid treatment device; and

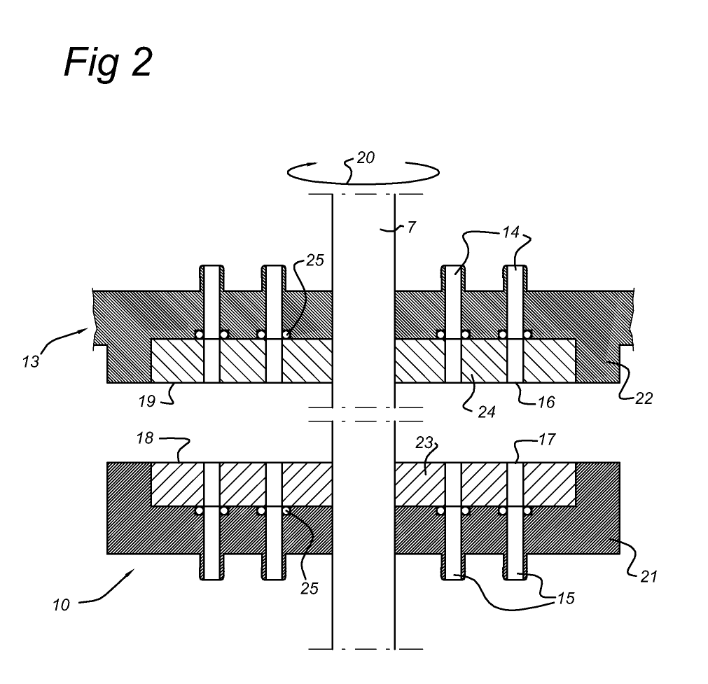

FIG. 2 shows a detail of the valve assembly used therein.

In FIG. 1 a fluid treatment device is generally referred to by 1. This device generally corresponds to what is shown in EP 1067997 B1. A rotably arranged carrier 6 is provided for rotatably carrying a number of fluid treatment columns 2 each having a feed line 3 and a discharge line 4. Rotation of the carrier 6 is effected through rotation of a shaft 7 connected thereto being driven by motor 8. Shaft 7 also rotates the rotating valve plate 13 of valve assembly 9. It should be understood that this is only an example and that is quite imaginable that the valve assembly 9 is separate from the carrier and driven indirectly or driven separately or driven intermittently.

The stationary valve plate 10 of valve assembly 9 has feed lines 11 and discharge lines 12 connected thereto. The valve assembly 9 functions to connect lines 3 and in different sequences with one of the lines 11 and 12. To that end both the stationary valve plate 10 and rotary valve plate 13 are provided with conduits 15 respectively 14 (FIG. 2) extending there through and being provided at one side with connection to the related conduits and on the other site with openings 17 (first opening) and 16 (second opening) respectively. Openings 16 and 17 are registered in discrete relative rotative position of the rotating valve plate 13 (direction of rotation is indicated by arrow 20) relative to the stationary valve plate 10. In this way fluid flows in different direction and different kind of fluids can be conveyed through each of the columns 2 as desired.

Each valve plate 10, 13 comprises a support 21 respectively 22 having an accommodation for receiving pieces of plastic material or sealing plates 23, 24 respectively. Sealing between the sealing plates 23, 24 and support plates 21/22 is effected with O-rings 25 at a location of the fluid channels 14, 15.

The front surfaces 18, 19 of the stationary plate 10 and rotary plate 13 respectively are the most critical parts of the valve assembly. Except from the fact that the front surfaces should stand pressure and temperature as well as attack of the related fluid, which requirements should also be met by the other parts of the valve assembly being in possible contact with the fluid, it should also have optimum properties for running over each other. In other words the friction between surface 18 and surface 19 should be relatively low. Furthermore the material properties of both surfaces should be such that no damage will occur during rotation relative to each other.

To that end according to the invention a combination of materials is proposed.

According to the invention both surfaces are made from a plastic material which is relatively cheap to obtain and has high resistance against several chemicals. Based on temperature and pressures to be expected a further choice can be made. However according to subject invention one of said surfaces comprises a polyethylene based plastic and more particular an ultra high molecular weight polyethylene. The other of the surfaces is preferably a polytetrafluoroethylene material. More particular the rotating surface comprises PTFE whilst the stationary surface comprises ultra high molecular weight polyethylene.

It has been found that this combination can withstand temperatures above 100° C. and relatively high pressures while damage through fretting or other attack between the plastic material parts rotating relative to each other can be avoided. It should be understood that the plastic material can comprise a plate having a thickness of several mm to several cms. However it is also possible to coat a support with a very thin layer of the plastics.

It has been found that the combination of two plastics and more particular PTFE/ultra high molecular weight polyethylene can reduce wear considerably over the generally known combination PTFE hastelloy. As example a decrease of more than 99% is mentioned. It has been found that both in dry conditions and in the presence of water such decrease can be obtained. Also a decrease in friction between the materials relative to the prior art has been observed further reducing negative effects of two surfaces sliding over each other.

The device described above is only an example of the invention. Feed and discharge could be reversed whilst a number of columns could be connected in series and/or parallel.

After the above further embodiments and applications of subject invention will become immediately clear for the persons skilled in the art and are obvious in view of the appended claims. Furthermore expressively rights are claimed for embodiments disclosed in the sub-claims without their dependency from the independent claims.

1. Valve assembly for a fluid treatment device comprising a stationary valve plate being provided with fluid channels, said fluid channels extending from first openings in a front surface of said valve plate to fluid line connections on said valve plate, and a rotary valve plate having a front surface provided with second openings opening in fluid channels in said rotary valve plate, said front surfaces of said stationary and rotary valve plate being directed towards each other and wherein said first and second openings are positioned in register in determined relative rotative positions of said stationary and rotary valve plate, characterized in that, the front surface of one of said valve plates comprises a plastic and the front surface of the other of said valve plate comprises a polyethylene based plastic.

2. Valve assembly according to claim 1, wherein said polyethylene based plastic comprises an ultra high molecular weight polyethylene.

3. Valve assembly according to claim 2, wherein the molecular weight of said ultra high molecular weight PE is 1,000,000-10,000,000 g/mol and more particular 2,000,000-8,000,000 g/mol.

4. Valve assembly according to claim 1, wherein said plastic surface of said one valve plate comprises Teflon (PTFE).

5. Valve assembly according to claim 1, wherein said one of said valve plates is a stationary valve plate.

6. Valve assembly according to claim 1, wherein said plastic material of said front surface is backed by a metallic support.

7. Valve assembly according to claim 6 wherein between said plastic material of said front surface and said metallic support at the position of a fluid channel an O-ring is provided.

8. Fluid treatment device comprising a carrier for a fluid treatment column, said column being provided with a feed and discharge line being connected to a rotating valve assembly according to one of the preceding claims, wherein the rotary valve plate thereof is substantially corotating with said carrier, and said stationary valve plate is provided with feed and discharge conduits.

9. Valve assembly according to claim 2, wherein said plastic surface of said one valve plate comprises Teflon (PTFE).

10. Valve assembly according to claim 3, wherein said plastic surface of said one valve plate comprises Teflon (PTFE).

11. Valve assembly according to claim 2, wherein said one of said valve plates is a stationary valve plate.

12. Valve assembly according to claim 3, wherein said one of said valve plates is a stationary valve plate.

13. Valve assembly according to claim 4, wherein said one of said valve plates is a stationary valve plate.

14. Valve assembly according to claim 9, wherein said one of said valve plates is a stationary valve plate.

15. Valve assembly according to claim 10, wherein said one of said valve plates is a stationary valve plate.

16. Valve assembly according to claim 2, wherein said plastic material of said front surface is backed by a metallic support.

17. Valve assembly according to claim 3, wherein said plastic material of said front surface is backed by a metallic support.

18. Valve assembly according to claim 4, wherein said plastic material of said front surface is backed by a metallic support.

19. Valve assembly according to claim 5, wherein said plastic material of said front surface is backed by a metallic support.

20. Valve assembly according to claim 9, wherein said plastic material of said front surface is backed by a metallic support.

21. Valve assembly according to claim 10, wherein said plastic material of said front surface is backed by a metallic support.

22. Valve assembly according to claim 11, wherein said plastic material of said front surface is backed by a metallic support.

23. Valve assembly according to claim 12, wherein said plastic material of said front surface is backed by a metallic support.

24. Valve assembly according to claim 13, wherein said plastic material of said front surface is backed by a metallic support.

25. Valve assembly according to claim 14, wherein said plastic material of said front surface is backed by a metallic support.

26. Valve assembly according to claim 15, wherein said plastic material of said front surface is backed by a metallic support.

27. Valve assembly according to claim 16, wherein between said plastic material of said front surface and said metallic support at the position of a fluid channel an O-ring is provided.

28. Valve assembly according to claim 17, wherein between said plastic material of said front surface and said metallic support at the position of a fluid channel an O-ring is provided.

29. Valve assembly according to claim 18, wherein between said plastic material of said front surface and said metallic support at the position of a fluid channel an O-ring is provided.

30. Valve assembly according to claim 19, wherein between said plastic material of said front surface and said metallic support at the position of a fluid channel an O-ring is provided.

31. Valve assembly according to claim 20, wherein between said plastic material of said front surface and said metallic support at the position of a fluid channel an O-ring is provided.

32. Valve assembly according to claim 21, wherein between said plastic material of said front surface and said metallic support at the position of a fluid channel an O-ring is provided.

33. Valve assembly according to claim 22, wherein between said plastic material of said front surface and said metallic support at the position of a fluid channel an O-ring is provided.

34. Valve assembly according to claim 23, wherein between said plastic material of said front surface and said metallic support at the position of a fluid channel an O-ring is provided.

35. Valve assembly according to claim 24, wherein between said plastic material of said front surface and said metallic support at the position of a fluid channel an O-ring is provided.

36. Valve assembly according to claim 25, wherein between said plastic material of said front surface and said metallic support at the position of a fluid channel an O-ring is provided.

37. Valve assembly according to claim 26, wherein between said plastic material of said front surface and said metallic support at the position of a fluid channel an O-ring is provided.
